(19) United States
(12) Patent Application Publication
(10) Pub. No.: US 2011/0306729 A1
(43) Pub. Date: Dec. 15, 2011

(54) CROSS-LINKING COMPOSITION IN THE FORM OF GRANULES FOR PREPARING CROSS-LINKED BITUMEN/ELASTOMER COMPOSITIONS

(75) Inventors: Sylvia Dreessen, Solaize (FR); Julien Chaminand, Vaulx En Vellin (FR); Sophie Mariotti, Lyon (FR); Patrice Laurent, Viroflay (FR)

(73) Assignee: TOTAL RAFFINAGE MARKETING, Puteaux (FR)

(21) Appl. No.: 13/127,329

(22) PCT Filed: Mar. 2, 2010
(86) PCT No.: PCT/IB2010/050892

§ 371 Date: May 3, 2011

(30) Foreign Application Priority Data
Mar. 3, 2009 (FR) 09 00946

(51) Int. Cl. C08L 53/00; C08L 31/04

(52) U.S. Cl. 525/94; 525/55

(57) ABSTRACT

The disclosure relates to a cross-linking composition in pellet form including at least one polymer matrix, at least one cross-linking agent and at least one hydrogen sulphide inhibiting agent, the hydrogen sulphide inhibiting agent including at least one zinc carboxylate and at least one triazine derivative. It also relates to its preparation method.

### CROSS-REFERENCE TO RELATED APPLICATIONS

This application is a National Phase Entry of International Application No. PCT/IB2010/050892, filed on Mar. 2, 2010, which claims priority to French Patent Application Serial No. 09 00946, filed on Mar. 3, 2009, both of which are incorporated by reference herein.

### TECHNICAL FIELD

The present invention belongs to the field of bitumens, in particular to the field of bitumen/elastomer compositions. More specifically, the invention relates to a cross-linking composition for bitumen/elastomer compositions, in pellet form, making it possible to prepare cross-linked bitumen/elastomer compositions having reduced hydrogen sulphide emissions. The invention also relates to the method for preparing cross-linked bitumen/elastomer compositions using the cross-linking compositions in pellet form, a method in which the hydrogen sulphide emissions are reduced. The invention finally relates to the use of the cross-linking compositions in pellet form for preparing cross-linked bitumen/elastomer compositions while limiting the hydrogen sulphide emissions.

### BACKGROUND

The use of bitumen in the manufacture of materials for highway and industrial applications has been known for a long time: bitumen is the main hydrocarbon binder used in the field of road construction or civil engineering. To be able to be used as a binder in these different applications, the bitumen must have certain chemical, physical and mechanical properties. It is well known that the properties of pure bitumens can be modified by the addition of polymers, in particular elastomers. For example, mention may be made of the addition of styrene and butadiene copolymers. It is also well known that the resistance to mechanical and thermal stresses, and the rheological, elastic, and mechanical performances, of the bitumen/polymer compositions, and in particular of the bitumen/elastomer compositions, are clearly improved when the polymers, and in particular the elastomers such as the styrene and butadiene copolymers, are cross-linked using sulphur-based cross-linking agents.

During the preparation of the bitumen/polymer compositions, and in particular of the bitumen/elastomer compositions, which are cross-linked with sulphur, the addition of sulphur can lead to emissions of hydrogen sulphide (also called sulphureted hydrogen or H₂S). Hydrogen sulphide is a colourless and fairly toxic gas, which also has a characteristic odour at a very low concentration. The hydrogen sulphide emissions can therefore be a nuisance to those preparing the bitumen/polymer compositions, and in particular the bitumen/elastomer compositions, which are cross-linked using sulphur-based cross-linking agents. It would therefore be desirable for the workers' comfort and safety to reduce or even eliminate the hydrogen sulphide emissions during the preparation of cross-linked bitumen/polymer compositions, and in particular of bitumen/elastomer compositions.

In most methods for cross-linking with sulphur, different sulphur-based cross-linking agents are added to the bitumen/polymer, in particular the bitumen/elastomer compositions. These are added separately to the bitumen/polymer, in particular bitumen/elastomer compositions, and therefore have to be stored and weighed separately. Moreover, the usual various sulphur-based cross-linking agents are compounds in the form of powder, which are sensitive to humidity and may harden during storage and as a result be difficult to handle. These powders are also fairly volatile and can cause fires and/or explosions. It would therefore be desirable to be able to prepare bitumen/polymer, in particular bitumen/elastomer compositions, which are cross-linked, using sulphur-based cross-linking agents, while reducing the hydrogen sulphide emissions as much as possible, using a cross-linking system without the drawbacks of the conventionally used sulphur-based cross-linking agents in powder form.

U.S. Pat. No. 7,402,619 describes a cross-linking composition which may be in pellet or powder form. This cross-linking composition comprises 5 to 50% elemental sulphur, 0.5 to 10% sulphur derivatives, 5 to 50% zinc derivatives, 5 to 50% fatty acid derivatives and 10 to 85% polymer matrix. Furthermore the quantity of zinc in the cross-linking composition is at least 2% by mass and the mass ratio between the quantities of zinc and sulphur is comprised between 0.5:1 and 2:1. This significant quantity of zinc relative to the quantity of sulphur makes it possible to reduce hydrogen sulphide emissions during the preparation of bitumen/elastomer compositions using this cross-linking composition. This cross-linking composition is not however satisfactory and has several disadvantages. The cross-linking composition comprises too great a quantity of polymer matrix, a non-“active” element which is not involved in the cross-linking of the elastomer in the bitumen or in the inhibition of the hydrogen sulphide emissions. This significant quantity of polymer matrix is detrimental to the quantities of the “active” elements involved in the cross-linking or in the inhibition of the hydrogen sulphide emissions. In particular, the quantity of sulphur is fairly small in the cross-linking composition and in the bitumen/elastomer composition which does not allow optimum cross-linking of the elastomer, and does not make it possible to achieve the expected mechanical, rheological and elastic properties, except by considerably increasing the quantity of cross-linking composition in the bitumen/elastomer composition. The quantity of zinc in the composition relative to the quantity of sulphur is also unnecessarily very significant. Finally, the presence of fatty acid derivatives in the cross-linking composition is required.

### SUMMARY

The applicant company has also sought to develop a cross-linking composition in pellet form, allowing reduction in hydrogen sulphide emissions during the preparation of cross-linked bitumen/elastomer compositions, while retaining satisfactory mechanical, rheological and elastic properties in the cross-linked bitumen/elastomer compositions. The applicant company has surprisingly established that the combination of a zinc carboxylate and a triazine derivative made it possible to obtain a cross-linking composition in pellet form which is stable, handleable, simple to use and very effective in terms of cross-linking and reduction in hydrogen sulphide emissions, even with very low zinc contents, in particular relative to the sulphur contents. To this end, the invention proposes a cross-linking composition in pellet form comprising at least one polymer matrix, at least one cross-linking agent and at least one hydrogen sulphide inhibiting agent, the hydrogen sulphide inhibiting agent comprising at least one zinc carboxylate and at least one triazine derivative.

One of the objectives of the present invention is therefore to propose an alternative cross-linking composition in pellet form which is stable, handleable, simple to use, soluble in bitumen, reacting rapidly, leading to cross-linked bitumen/elastomer compositions having satisfactory mechanical, rheological and elastic characteristics, and making it possible to reduce hydrogen sulphide emissions during the preparation of said cross-linked bitumen/elastomer compositions. Another objective of the invention is to propose a simple, rapid and sure method for preparing cross-linked bitumen/elastomer compositions with reduced hydrogen sulphide emissions, in particular during the cross-linking of the bitumen/elastomer compositions and leading to cross-linked bitumen/elastomer compositions having satisfactory mechanical, rheological and elastic characteristics, this method involving a cross-linking composition in pellet form. Another objective of the invention is the use of a cross-linking composition in pellet form for preparing cross-linked bitumen/elastomer compositions, with reduced hydrogen sulphide emissions, the cross-linked bitumen/elastomer compositions thus prepared having satisfactory mechanical, rheological and elastic characteristics.

### BRIEF DESCRIPTION

The invention relates to a cross-linking composition in pellet form comprising at least one polymer matrix, at least one cross-linking agent and at least one hydrogen sulphide inhibiting agent, the hydrogen sulphide inhibiting agent comprising at least one zinc carboxylate and at least one triazine derivative. Preferably, the zinc carboxylate is chosen from zinc acetate, zinc ethanoate, zinc propionate, zinc butyrate, zinc pentanoate, zinc hexanoate, zinc heptanoate, zinc octoate, zinc 2-ethyl hexanoate, zinc nonanoate, zinc dodecanoate, zinc undecanoate, zinc benzoate, zinc laurate, zinc palmitate, zinc stearate, zinc oleate, alone or in a mixture. Preferably, the triazine derivative is chosen from the tri-alkyl hexahydrotriazines, the tri-hydroxyalkyl hexahydrotriazines, the alkyl group of which comprises 1 to 12 carbon atoms, preferably 2 to 8 carbon atoms, alone or in a mixture.

Preferably, the polymer matrix is chosen from the polyethylenes, ethylene/propylene copolymers, ethylene/acrylic ester copolymers, ethylene/glycol monostearate copolymers, ethylene/vinyl acetate copolymers, alone or in a mixture. Preferably, the cross-linking agent comprises sulphur optionally in combination with vulcanization (curing) accelerators chosen from the mercaptobenzothiazole derivatives and dithiocarbamates, alone or in a mixture. Preferably, the quantity of zinc carboxylate is comprised between 5% and 50%, by mass, with respect to the total mass of the cross-linking composition in pellet form, preferably between 10% and 40%, more preferentially between 20% and 30%.

Preferably, the quantity of triazine derivative is comprised between 5% and 40%, by mass, with respect to the total mass of the cross-linking composition in pellet form, preferably between 10% and 30%, more preferentially between 15% and 20%. Preferably, the mass ratio of the quantities of zinc carboxylate and triazine derivative is comprised between 0.5 and 8, preferably between 1 and 5, more preferentially between 2 and 3. Preferably, the quantity of zinc in the cross-linking composition in pellet form is comprised between 1% and 15% by mass, with respect to the total mass of the cross-linking composition in pellet form, preferably between 2% and 10%, still more preferentially between 3% and 5%. Preferably, the quantity of sulphur in the cross-linking composition in pellet form is comprised between 5% and 50% by mass, with respect to the total mass of the cross-linking composition in pellet form, preferably between 10% and 40%, more preferentially between 20% and 30%. Preferably, the mass ratio between the quantities of zinc and sulphur is comprised between 0.01 and 0.3, preferably between 0.02 and 0.2, more preferentially between 0.04 and 0.1, still more preferentially between 0.05 and 0.08.

The invention also relates to the method for preparing a cross-linking composition in pellet form as defined above, in which the cross-linking composition in pellet form is obtained by extrusion at a temperature below 110° C. The invention also relates to the use of the cross-linking composition in pellet form as defined above, for preparing cross-linked bitumen/elastomer compositions. The invention also relates to the use of the cross-linking composition in pellet form as defined above, for reducing hydrogen sulphide emissions during the preparation of cross-linked bitumen/elastomer compositions. The invention finally relates to a method for preparing cross-linked bitumen/elastomer compositions utilizing at least one bitumen, at least one elastomer and at least one cross-linking composition in pellet form as defined above.

Preferably, the method for preparing cross-linked bitumen/elastomer compositions comprises the following stages:

(i) heating at least one bitumen to a temperature comprised between 160° C. and 200° C.,
(ii) adding at least one elastomer and stirring the bitumen/elastomer mixture, at a temperature comprised between 160° C. and 200° C.,
(iii) adding a cross-linking composition in pellet form as defined above, stirring the bitumen/elastomer mixture/cross-linking composition in pellet form, at a temperature comprised between 160° C. and 200° C.

Preferably, the quantity of bitumen is comprised between 75% and 98% by mass, preferably between 80% and 96%, more preferentially between 85% and 95%, with respect to the total bitumen/elastomer composition/cross-linking composition in pellet form. Preferably, the quantity of elastomer is comprised between 1% and 15% by mass, preferably between 2% and 10%, more preferentially between 3% and 5%, with respect to the total bitumen/elastomer composition/cross-linking composition in pellet form. Preferably, the quantity of cross-linking composition in pellet form as defined above is comprised between 0.05% and 5% by mass, preferably between 0.1% and 2%, more preferentially between 0.15% and 1%, still more preferentially between 0.2% and 0.5%, with respect to the total bitumen/elastomer composition/cross-linking composition in pellet form. Preferably, the ratio between the quantities of sulphur and elastomer is comprised between 0.005 and 0.05, preferably between 0.01 and 0.03, more preferentially between 0.02 and 0.025. The invention finally relates to a cross-linked bitumen/elastomer composition capable of being obtained by the preparation method as defined above.

### DETAILED DESCRIPTION

The cross-linking composition according to the invention is in pellet form and comprises at least one polymer matrix, at least one cross-linking agent and at least one hydrogen sulphide inhibiting agent, the hydrogen sulphide inhibiting agent comprising at least one zinc carboxylate and at least one triazine derivative. One of the essential elements of the cross-linking composition according to the invention is the presence of at least one hydrogen sulphide inhibiting agent, which traps the hydrogen sulphide emissions released during the introduction of the cross-linking agent into the bitumen/elastomer composition, said agent being a combination of at least one zinc carboxylate and at least one triazine derivative. This combination is essential to the invention and makes it possible for the pellet to be handleable and is very effective in terms of reducing the hydrogen sulphide emissions with very low zinc levels and zinc to sulphur ratios in comparison with the prior art.

By zinc carboxylate is meant all the compounds corresponding to the general formula [RCOO]₂Zn in which R represents a hydrocarbon group chosen from the cyclic or non-cyclic, linear or branched alkyls, aryls, aralkyls or alkaryl groups, having 1 to 29 carbon atoms, preferably 6 to 20 carbon atoms, more preferentially 7 to 17 carbon atoms, still more preferentially 11 to 15 carbon atoms. Among the preferred zinc carboxylates the following can be mentioned: zinc acetate, zinc ethanoate, zinc propionate, zinc butyrate, zinc pentanoate, zinc hexanoate, zinc heptanoate, zinc octoate, zinc 2-ethyl hexanoate, zinc nonanoate, zinc dodecanoate, zinc undecanoate, zinc benzoate and the zinc carboxylates derived from fatty acids such as zinc laurate, zinc palmitate, zinc stearate, zinc oleate. The preferred zinc carboxylates are zinc acetate, zinc benzoate, zinc octoate and zinc stearate, in particular zinc stearate which is a zinc carboxylate that is available and inexpensive. Independently of the nature of the zinc carboxylate used, an inhibition of the hydrogen sulphide emissions is noted. The inhibition would appear to be more effective in the case of the carboxylates comprising an R group having 1 to 6 carbon atoms, such as for example zinc acetate or zinc benzoate. The presence of fatty acid derivatives and in particular of zinc carboxylates derived from fatty acids is not indispensable.

The quantity of zinc carboxylate in the cross-linking composition in pellet form is comprised between 5% and 50% by mass, preferably between 10% and 40%, still more preferentially between 20% and 30%; with respect to the mass of the cross-linking composition in pellet form. The range between 10% and 20% is preferred. This quantity of zinc carboxylate is an ideal compromise vis-à-vis the quantities of cross-linking agent and polymer matrix in the cross-linking composition in pellet form. This makes it possible both to sufficiently trap the hydrogen sulphide emissions, to sufficiently cross-link the bitumen/elastomer composition and to have a handleable and stable pellet. A smaller quantity of zinc carboxylate is not suitable, as a certain quantity of zinc carboxylate in the pellet is necessary to trap the hydrogen sulphide released. A greater quantity of zinc carboxylate does not make it possible to formulate a pellet allowing both good cross-linking and easy handling, as this would involve reducing the quantities of cross-linking agent and/or polymer matrix.

Preferably, the zinc carboxylate according to the invention comprises a quantity of zinc comprised between 5% and 30% by mass, preferably between 10% and 20%, with respect to the mass of zinc carboxylate. The quantity of zinc in the cross-linking composition in pellet form is limited due in particular to the low zinc content in zinc carboxylates.

Preferably, the quantity of zinc in the cross-linking composition in pellet form is comprised between 1% and 15% by mass, preferably between 2% and 10%, still more preferentially between 3% and 5%, with respect to the total mass of the cross-linking composition in pellet form. The zinc comes mainly from the zinc carboxylate, but also from the vulcanization accelerators when they are used. Contrary to what was advocated in the prior art, the quantity of zinc in the composition in pellet form according to the invention is not very great but sufficient to trap a significant quantity of hydrogen sulphide. The quantity of zinc in the cross-linking composition in pellet form is limited due in particular to the low zinc content in zinc carboxylates and vulcanization (curing) accelerators.

By triazine derivative is meant the derivatives of 1,2,3-triazine, 1,2,4-triazine and 1,3,5-triazine (or s-triazine). The hydrated derivatives of triazine are preferred. Similarly, as regards the substituents borne by the nitrogen atoms of the triazine, the alkyl and/or hydroxalkyl substituents comprising 1 to 12 carbon atoms, preferably 2 to 8 carbon atoms are preferred. The tri-hydroxyalkyl hexahydrotriazines, the alkyl group of which comprises 1 to 12 carbon atoms, preferably 2 to 8 carbon atoms, are the preferred triazine derivatives, and in particular N,N′,N″-tris(2-hydroxyethyl)-hexahydrotriazine.

The quantity of triazine derivative in the cross-linking composition in pellet form is comprised between 5% and 40% by mass, with respect to the mass of the cross-linking composition in pellet form, preferably between 10% and 30%, still more preferentially between 15% and 20%. The range between 10% and 20% is preferred. A greater quantity of triazine derivative does not make it possible to correctly shape the cross-linking composition in pellet form. In fact, the triazine derivatives which can be used according to the invention are liquid compounds at ambient temperature. If the quantity of these liquid compounds is too great, the cross-linking composition in pellet form has the appearance of a foam and is unusable. The cross-linking composition in pellet form is sticky and cannot be cut and formulated in pellet form. A smaller quantity of triazine derivative is also not suitable, as a certain quantity of triazine derivative is necessary in the cross-linking composition in pellet form in order to trap the hydrogen sulphide emissions.

The combination of zinc carboxylate and triazine derivative is therefore essential in order to obtain both a cross-linking composition which can be extruded and cut in pellet form and in order to best trap the hydrogen sulphide emissions. The quantity of hydrogen sulphide inhibiting agent in the cross-linking composition in pellet form is comprised between 10% and 60% by mass, with respect to the mass of the cross-linking composition in pellet form, preferably between 20% and 50%, still more preferentially between 30% and 40%.

The mass ratio between the quantities of zinc carboxylate and triazine derivative is comprised between 0.5 and 8, preferably between 1 and 5, more preferentially between 2 and 3. This ratio makes it possible to obtain a cross-linking composition in pellet form which is stable and handleable and to best trap the hydrogen sulphide emissions. It is preferred to use a combination of hydrogen sulphide inhibiting agent comprising a little more zinc carboxylate than triazine derivative in order to obtain a pellet which is more stable and easier to extrude. The mass ratio between the quantities of zinc carboxylate and triazine derivative is therefore preferably greater than or equal to 1, or even greater than 1.

In order to prepare the cross-linked bitumen/elastomer compositions, the cross-linking composition in pellet form also comprises at least one cross-linking agent. The quantity of cross-linking agent in the cross-linking composition in pellet form is comprised between 5% and 50% by mass, preferably between 10% and 40%, more preferentially between 20% and 30%, with respect to the mass of the cross-linking composition in pellet form. The quantity of cross-linking agent is adjusted as a function of the quantity of elastomer to be cross-linked in the bitumen/elastomer composition. The quantity of cross-linking agent must be sufficient to allow the cross-linking of all the elastomer present in the bitumen/elastomer compositions to be cross-linked.

Preferably, the cross-linking agent comprises sulphur optionally in combination with vulcanization (curing) accelerators. Advantageously the sulphur used is elemental sulphur or flowers of sulphur and preferably the orthorhombic crystallized sulphur known by the name of alpha sulphur.

The quantity of sulphur in the cross-linking composition in pellet form is comprised between 5% and 50% by mass, preferably between 10% and 40%, more preferentially between 20% and 30%, with respect to the mass of the cross-linking composition in pellet form. The range between 30% and 40% is preferred. The quantity of sulphur is adjusted as a function of the quantity of elastomer to be cross-linked in the bitumen/elastomer composition. The quantity of sulphur must be sufficient to allow the cross-linking of all the elastomer present in the bitumen/elastomer compositions to be cross-linked. This quantity of sulphur represents the quantity of flowers of sulphur in the cross-linking composition in pellet form. The sulphur present in the vulcanization accelerators is not taken into account.

The quantity of sulphur in the pellet is preferably chosen so as to obtain a mass ratio between the quantities of zinc (in the zinc carboxylate and vulcanization accelerators when they are present) and of sulphur comprised between 0.01 and 0.3, preferably between 0.02 and 0.2, more preferentially between 0.04 and 0.1, still more preferentially between 0.05 and 0.08. Contrary to what was advocated in the prior art, the ratio between the quantities of zinc and sulphur in the cross-linking composition in pellet form according to the invention, is very low but sufficient, in combination with the triazine derivative, to trap a significant quantity of hydrogen sulphide.

It is also possible to add vulcanization accelerators in order to accelerate the cross-linking of the bitumen/elastomer compositions. These vulcanization accelerators are chosen from hydrocarbyl polysulphides, thiuram polysulphides, thiuram monosulphides, mercaptobenzothiazole derivatives and dithiocarbamates, alone or in a mixture. These different vulcanization accelerators are well known in the state of the art and reference can for example be made to the patents FR2528439, EP0360656 and EP0409683.

It is preferred to use as vulcanization accelerators the mercaptobenzothiazole derivatives and the dithiocarbamates, preferably in combination, more preferentially a 50/50 combination of mercaptobenzothiazole derivatives and dithiocarbamates. The preferred mercaptobenzothiazole derivative is zinc 2-mercaptobenzothiazole (ZMBT). The preferred dithiocarbamate is zinc dibutyldithiocarbamate (ZDBC). The quantity of vulcanization accelerators in the pellet is comprised between 0% and 5% by mass, preferably between 0.1% and 3%, more preferentially between 0.5% and 2%, with respect to the mass of the cross-linking composition in pellet form. The presence of vulcanization accelerators is preferably recommended, as they would make it possible to accelerate the cross-linking of the elastomer in the bitumen. The sulphur would react more rapidly on the elastomer and in this way the hydrogen sulphide emissions would be reduced.

The quantity of vulcanization accelerators in the pellet is preferably chosen so as to obtain a mass ratio between the quantities of vulcanization accelerators and sulphur comprised between 0.02 and 0.10, preferably between 0.03 and 0.08, more preferentially between 0.05 and 0.06. Preferably, the vulcanization accelerators include a quantity of zinc comprised between 5% and 30% by mass, preferably between 10% and 20%, more preferentially approximately 15%, with respect to the mass of the vulcanization accelerators.

In order to be able to shape the cross-linking composition in pellet form, the latter must comprise a polymer matrix, which makes it possible to bind the different constituents of the pellet to each other. This polymer matrix allows shaping by extrusion in pellet form. The polymer matrix preferably comprises a plastomer. This plastomer is, preferably, a plastomer comprising ethylene units. Preferably, the polymer matrix is chosen from the polyethylenes (PE), ethylene/propylene copolymers, ethylene/acrylic ester copolymers, ethylene/glycol monostearate copolymers, ethylene/vinyl acetate copolymers (EVA) alone or in a mixture.

The quantity of polymer matrix in the pellet is comprised between 5% and 50% by mass, with respect to the mass of the cross-linking composition in pellet form, preferably between 10% and 40%, more preferentially between 20% and 30%. A greater quantity of polymer matrix is not desirable as the latter is not involved in the elastomer cross-linking and the inhibition of hydrogen sulphide emission processes (it serves only to make it possible to shape the cross-linking composition in pellet form). It is therefore sought to limit the quantity of polymer matrix to a minimum, the limit clearly being imposed by the shaping in pellet form.

Preferably the composition in pellet form according to the invention comprises:

10% to 50% cross-linking agent,

10% to 40% hydrogen sulphide inhibiting agent,

5% to 40% polymer matrix.

More preferentially, the composition in pellet form according to the invention comprises:

10% to 50% sulphur,

0% to 5% vulcanization accelerators,

5% to 20% zinc carboxylate,

5% to 20% triazine derivative,

5% to 35% polymer matrix.

Still more preferentially, the composition in pellet form according to the invention comprises:

10% to 50% sulphur,

1% to 5% vulcanization accelerators,

5% to 20% zinc carboxylate,

5% to 20% triazine derivative,

5% to 35% polymer matrix.

The invention also relates to the method for preparing cross-linking compositions in pellet form according to the invention. The cross-linking compositions in pellet form according to the invention are obtained by extrusion and sieving the different constituents. The extrusion temperature is below 110° C., preferably below 90° C. It is possible to carry out pre-mixing of the hydrogen sulphide inhibitors when one of the inhibitors is a powder at ambient temperature and the other inhibitor is a liquid at ambient temperature, before passing through the extruder, then the sieve. The cross-linking compositions in pellet form according to the invention have dimensions comprised between 3 mm and 20 mm, preferably between 5 mm and 15 mm, in general.

The invention also relates to the use of the cross-linking compositions in pellet form according to the invention, for preparing cross-linked bitumen/elastomer compositions. The use of cross-linking compositions in pellet form according to the invention makes it possible to cross-link the bitumen/elastomer compositions with reduced hydrogen sulphide emissions. The invention also relates to the method for preparing cross-linked bitumen/elastomer compositions using the cross-linking compositions in pellet form according to the invention. For this, the cross-linkable composition in pellet form as defined above, at least one bitumen and at least one cross-linkable elastomer are used.

The bitumen which can be used according to the invention can be a bitumen obtained from different origins. The bitumen which can be used according to the invention can be chosen from the bitumens of natural origin, i.e. those contained in deposits of natural bitumen, natural asphalt or bituminous sands, the bitumens originating from the refining of crude oil such as the bitumens originating from atmospheric and/or vacuum distillation of oil, these bitumens being able to be optionally blown, visbroken and/or de-asphalted. The bitumens used can also be bitumens fluxed by the addition of volatile solvents, fluxes originating from oil, carbochemical fluxes and/or fluxes of vegetable origin. It is also possible to use synthetic bitumens also known as clear, pigmentable or colourable bitumens.

Between 75% and 98% by mass of bitumen, with respect to the total mass of bitumen/elastomer/cross-linking composition in pellet form, preferably between 80% and 96%, more preferentially between 85% and 95% is preferably used. The range between 95% and 98% is preferred.

The elastomers which can be used according to the invention are the elastomers which can be used in a standard fashion in the field of bitumens/polymers, in particular bitumens/elastomers, such as for example the polybutadienes, polyisoprenes, butyl rubbers, ethylene/propene/diene (EPDM) terpolymers, styrene and isoprene copolymers, styrene and butadiene copolymers, alone or in a mixture. The preferred elastomer is a styrene and butadiene copolymer such as the styrene/butadiene (SB) block copolymer or the styrene/butadiene/styrene (SBS) block copolymer. The styrene and butadiene copolymer advantageously has a styrene content by weight ranging from 5 to 50%, preferably 20 to 50%. The styrene and butadiene copolymer, advantageously has a (1,2 and 1,4) butadiene content by weight ranging from 50 to 95%. The styrene and butadiene copolymer advantageously has a 1,2 butadiene content by weight ranging from 5 to 70%. The 1,2 butadiene units are units which result from polymerization via the 1,2 addition of the butadiene units.

The average molecular mass of the styrene and butadiene copolymer can be comprised, for example, between 10,000 and 500,000, preferably between 50,000 and 200,000 and more preferentially between 50,000 and 150,000 Daltons. Between 1% and 15% by mass of elastomer, with respect to the total mass of bitumen/elastomer/cross-linking composition in pellet form, preferably between 2% and 10%, more preferentially between 3% and 5% is preferably used.

It is preferable to use, according to the invention, between 0.05% and 5%, preferably between 0.1% and 2%, more preferentially between 0.15% and 1%, still more preferentially between 0.2% and 0.5% by mass of cross-linking composition in pellet form with respect to the total mass of bitumen/elastomer/cross-linking composition in pellet form. The range between 0.1% and 0.2% is preferred. It is preferable to use a smaller quantity of cross-linking composition in pellet form. The cross-linking composition in pellet form must therefore have as high a concentration as possible of so-called active agents such as the cross-linking agent or the hydrogen sulphide inhibiting agent.

The quantity of cross-linking composition in pellet form to be introduced into the bitumen/elastomer composition is chosen so that the mass ratio of the quantities of sulphur and elastomer is comprised between 0.005 and 0.05, preferably between 0.01 and 0.03, more preferentially between 0.02 and 0.025. This ratio is very high and allows optimum cross-linking of the elastomer. A ratio of less than 0.005 does not make it possible to cross-link all of the elastomer present in the bitumen/elastomer composition. The elastic properties of the bitumen/elastomer composition would be insufficient if this ratio were less than 0.005.

The method for preparing cross-linked bitumen/elastomer compositions comprises the following essential stages:

(i) at least one bitumen is heated and mixed between 160° C. and 200° C., preferably between 180° C. and 190° C., preferably between 5 minutes and 120 minutes, more preferentially between 10 minutes and 60 minutes,
(ii) at least one elastomer is added, the bitumen/elastomer composition thus obtained is heated and mixed between 160° C. and 200° C., preferably between 180° C. and 190° C., preferably between 5 minutes and 240 minutes, more preferentially between 10 minutes and 120 minutes, still more preferentially between 30 minutes and 60 minutes,
(iii) the cross-linking composition in pellet form is added, the bitumen/elastomer composition/cross-linking composition in pellet form thus obtained is heated and mixed between 160° C. and 200° C., preferably between 180° C. and 190° C., preferably between 5 minutes and 120 minutes, more preferentially between 10 minutes and 60 minutes, in order to cross-link said bitumen/elastomer composition.
This method for preparing cross-linked bitumen/elastomer compositions is particularly simple to implement since it involves only three components: the bitumen, the elastomer and the cross-linking composition in pellet form which brings together all the components necessary for the cross-linking and for trapping the hydrogen sulphide.

The invention finally relates to the use of the cross-linking composition in pellet form as defined above for preparing cross-linked bitumen/elastomer compositions which can be used as bituminous binders in anhydrous form or in the form of an emulsion. This bituminous binder can be used in highway applications as a base course, binder course or wearing course and/or in industrial applications as a sealing membrane, membrane, impregnation layer. These bituminous binders then being able to be combined with aggregates in order to provide surface dressings, hot mixes, cold mixes, cold-cast mixes, gravel emulsions.

The cross-linking compositions in pellet form are prepared by a conventional extrusion method. Standard techniques and equipment are used. The extrusion temperature is preferably below 110° C., preferably also below 90° C. It is also possible to carry out premixing of the hydrogen sulphide inhibitors when one of the inhibitors is a powder at ambient temperature and the other inhibitor is a liquid at ambient temperature.

### EXAMPLES

The following are used:

A direct distillation bitumen having a penetrability measured at 25° C. according to the standard EN 1426 of 40 1/10 mm and a Ring and Ball Temperature measured according to the standard EN 1427 of 51.6° C.,

flowers of sulphur,

two vulcanization accelerators: zinc dibutyldithiocarbamate (ZDBC) at a zinc level of 14.3% and zinc 2-mercaptobenzothiazole (ZMBT) at a zinc level of 16%,
a linear block elastomer of styrene/butadiene/styrene type, comprising a styrene content by weight of 31%,
zinc stearate at a zinc level of 10.8% or zinc acetate at a zinc level of 29%,
N,N′,N″-tris(2-hydroxyethyl)₆hexahydrotriazine,
a plastomer of ethylene/vinyl acetate type having a vinyl acetate level of 20% by mass and a melt index of 20 g/10 min,
carbon black,
a polyisobutylene tackifier with a high molecular weight on an LLDPE (Linear Low Density Polyethylene) support.

Cross-linking compositions in pellet form are prepared as controls (G₁, G₂ and G₃) and according to the invention (G₄, G₅ and G₆). The cross-linking compositions in pellet form according to the invention G₄ and G₅ comprise as hydrogen sulphide inhibiting agent a combination of a particular zinc carboxylate, zinc stearate, and triazine derivative. The cross-linking composition in pellet form according to the invention G₆ comprises as hydrogen sulphide inhibiting agent a combination of a particular zinc carboxylate, zinc acetate, and triazine derivative. The control cross-linking compositions in pellet form comprise no hydrogen sulphide inhibiting agent (G₁) or comprise as hydrogen sulphide inhibiting agent only a particular zinc carboxylate, zinc stearate (G₂) or zinc acetate (G₃).

The cross-linking compositions in pellet form are prepared by a conventional extrusion method. Standard techniques and equipment are used. The extrusion temperature is below 110° C., preferably below 90° C. It is also possible to carry out premixing of the hydrogen sulphide inhibitors when one of the inhibitors is a powder at ambient temperature and the other inhibitor is a liquid at ambient temperature.

All the cross-linking compositions in pellet form, thus obtained, are stable and handleable. The cross-linking compositions in pellet form have the compositions given in Table I (% by mass).

TABLE I

| | G₁ | G₂ | G₃ | G₄ | G₅ | G₆ |
|---|---|---|---|---|---|---|
| Sulphur | 60 | 40 | 40 | 40 | 40 | 40 |
| ZDBC | 1.87 | 1.25 | 1.25 | 1.25 | 1.25 | 1.25 |
| ZMBT | 1.87 | 1.25 | 1.25 | 1.25 | 1.25 | 1.25 |
| EVA | 33.86 | 25.1 | 25.1 | 25.1 | 25.1 | 25.1 |
| Zinc stearate | — | 30 | — | 20 | 10 | — |
| Zinc acetate | — | — | 30 | — | — | 20 |
| Triazine | — | — | — | 10 | 20 | 10 |
| Carbon black | 0.4 | 0.4 | 0.4 | 0.4 | 0.4 | 0.4 |
| Tackifier | 2 | 2 | 2 | 2 | 2 | 2 |

The quantity of zinc (% by mass) in the composition is calculated as a function of the zinc level present in the zinc carboxylates and in the vulcanization accelerators. The quantities of zinc in the cross-linking compositions in pellet form G₁ to G₆ are respectively 0.56%, 3.61%, 9.07%, 2.53%, 1.45% and 6.17%. The mass ratio of the quantities of zinc and sulphur in the cross-linking compositions in pellet form G₁ to G₆ are respectively 0.009, 0.090, 0.226, 0.063, 0.036 and 0.154.

Different bitumen/elastomer compositions C₁ to C₆ respectively cross-linked with the different vulcanizing compositions in pellet form G₁ to G₆ of Table I are prepared. The bitumen/elastomer compositions C₁ to C₆ are prepared as follows: A direct distillation bitumen as defined above is introduced into a 2-litre hermetic reactor under stirring (300 rpm) and at 185° C., heated for 10 minutes, an elastomer of styrene/butadiene/styrene type, as defined above, is added, the bitumen/elastomer mixture is heated at 185° C. for 4 hours, and finally a vulcanizing composition in pellet form as defined above is added, in the proportions of Table II below (% by mass). The mixture is stirred at 300 rpm and heated at 185° C. for 2 hours.

A non-cross-linked bitumen/elastomer composition C₀ is also prepared in the say way as above without the stage of addition of the vulcanizing composition in pellet form.

TABLE II

| | C₀ | C₁ | C₂ | C₃ | C₄ | C₅ | C₆ |
|---|---|---|---|---|---|---|---|
| Bitumen: | 97 | 96.9 | 96.85 | 96.85 | 96.85 | 96.85 | 96.85 |
| SBS Elastomer | 3 | 3 | 3 | 3 | 3 | 3 | 3 |
| Pellet | — | 0.1 | 0.15 | 0.15 | 0.15 | 0.15 | 0.15 |

The mass ratio of the quantities of sulphur and elastomer in the cross-linked bitumen/elastomer compositions C₁ to C₆ is 0.02.

Table III below shows the physical characteristics of the cross-linked bitumen/elastomer compositions according to the invention, compositions C₄, C₅ and C₆ respectively cross-linked using the cross-linking compositions in pellet form G₄, G₅ and G₆ and control cross-linked bitumen/elastomer compositions, compositions C₁, C₂ and C₃ cross-linked respectively using the cross-linking compositions in pellet form G₁, G₂ and G₃ and a control non-cross-linked bitumen/elastomer composition C₀.

TABLE III

| | C₀ | C₁ | C₂ | C₃ | C₄ | C₅ | C₆ |
|---|---|---|---|---|---|---|---|
| Penetrability (0.1 mm)⁽¹⁾ | 30 | 26 | 28 | 25 | 24 | 27 | 27 |
| RET (° C.)⁽²⁾ | 60.2 | 62.8 | 63.2 | 65.0 | 64.2 | 63.6 | 63.8 |
| PI⁽³⁾ | −0.4 | 0.1 | 0.3 | 0.4 | 0.2 | 0.3 | 0.4 |
| Threshold stress (MPa)⁽⁴⁾ | 1.75 | 1.67 | 1.58 | 1.62 | 1.54 | 1.68 | 1.60 |
| Max elongation (%)⁽⁴⁾ | 180 | 700 | 700 | 700 | 700 | 700 | 700 |
| Max elongation stress (MPa)⁽⁴⁾ | 0.18 | 0.74 | 0.7 | 0.66 | 0.68 | 0.72 | 0.72 |
| Energy at 400% elongation (J/cm²)⁽⁴⁾ | — | 13.88 | 12.7 | 13.07 | 12.56 | 12.34 | 12.10 |
| Total energy (J)⁽⁴⁾ | 0.86 | 2.85 | 2.38 | 2.61 | 2.28 | 2.88 | 2.58 |

⁽¹⁾According to the standard NF EN 1426.
⁽²⁾Ring and Ball Temperature according to the standard NF EN1427.
⁽³⁾Pfeiffer index according to the standard EN12591.
⁽⁴⁾Traction test at 5° C. according to the standards NF EN 13587 and EN 13703, with a stretching rate of 500 mm/min.

In the light of the results compiled in Table III, we are able to make the following comments:

All of the vulcanizing compositions in pellet form G₁ to O₆ make it possible to cross-link the bitumen/elastomer compositions C₁ to C₆. All of the elastomer present in these compositions is cross-linked. In fact, it is noted that the consistency of the cross-linked bitumen/elastomer compositions C₁ to C₆ is greater than that of the non-cross-linked bitumen/elastomer composition C₀ (see the penetrability and Ring and Ball Temperature values). Similarly, the values obtained in the traction test show that the cross-linked bitumen/elastomer compositions C₁ to C₆ are clearly more elastic than the non-cross-linked bitumen/elastomer composition C₀. Reference can be made for example to the elongation values obtained, which are 700% in the case of the cross-linked bitumen/elastomer compositions C₁ to C₆ and only 180% in the case of the non-cross-linked bitumen/elastomer composition C₀.

The hydrogen sulphide emissions released are measured in gas phase using a probe placed in the closed reaction medium, over 2 hours starting from the introduction of the cross-linking composition in pellet form into the bitumen/elastomer mixture. For each composition C₁ to C₆, a curve gives the hydrogen sulphide quantities released as a function of time. The curve corresponding to the cross-linked composition C₁ using a pellet comprising no hydrogen sulphide inhibitor is considered as the reference curve. The percentages of reduction in hydrogen sulphide emissions obtained during the cross-linking of the bitumen/elastomer compositions C₂ to C₆, with respect to the reference C₁, are shown in Table IV below:

TABLE IV

| | % reduction in hydrogen sulphide |
|---|---|
| | emissions with respect to C₁ |
| C₂ | 20 |
| C₃ | 32 |
| C₄ | 43 |
| C₅ | 47 |
| C₆ | 49 |

It is noted that the use of the cross-linking compositions in pellet form according to the invention G₄ to G₆, in which the hydrogen sulphide inhibiting agent is a combination of zinc carboxylate and triazine derivative, allows a clearly more significant reduction in hydrogen sulphide emissions. Thus, the hydrogen sulphide emissions are reduced by 43% and by 47% when a cross-linking composition comprising both zinc stearate and a triazine derivative is used (instead of only 20% when the stearate is used alone). Similarly, the combination of zinc acetate and triazine derivative makes it possible to reduce the hydrogen sulphide emissions by 49% (instead of 39% in the case of zinc acetate alone).

The cross-linking compositions in pellet form according to the invention therefore make it possible to obtain elastic cross-linked bitumen/elastomer compositions, while considerably reducing the hydrogen sulphide emissions.

1. A cross-linking composition in pellet form comprising at least one polymer matrix, at least one cross-linking agent and at least one hydrogen sulphide inhibiting agent, the hydrogen sulphide inhibiting agent comprising at least one zinc carboxylate and at least one triazine derivative.

2. The cross-linking composition in pellet form according to claim 1 wherein the zinc carboxylate is chosen from zinc acetate, zinc ethanoate, zinc propionate, zinc butyrate, zinc pentanoate, zinc hexanoate, zinc heptanoate, zinc octoate, zinc 2-ethyl hexanoate, zinc nonanoate, zinc dodecanoate, zinc undecanoate, zinc benzoate, zinc laurate, zinc palmitate, zinc stearate, zinc oleate, alone or in a mixture.

3. The cross-linking composition in pellet form according to claim 1 wherein the triazine derivative is chosen from the tri-alkyl hexahydrotriazines, the tri-hydroxyalkyl hexahydrotriazines, the alkyl group of which comprises 1 to 12 carbon atoms, alone or in a mixture.

4. The cross-linking composition in pellet form according to claim 1 wherein the polymer matrix is chosen from the polyethylenes, the ethylene/propylene copolymers, the ethylene/acrylic ester copolymers, the ethylene/glycol monostearate copolymers, the ethylene/vinyl acetate copolymers, alone or in a mixture.

5. The cross-linking composition in pellet form according to claim 1 wherein the cross-linking agent comprises sulphur optionally in combination with vulcanization accelerators chosen from the mercaptobenzothiazole derivatives and the dithiocarbamates, alone or in a mixture.

6. The cross-linking composition in pellet form according to claim 1 wherein the quantity of zinc carboxylate is comprised between 5% and 50%, by mass, with respect to the total mass of the cross-linking composition in pellet form.

7. The cross-linking composition in pellet form according to claim 1 wherein the quantity of triazine derivative is comprised between 5% and 40%, by mass, with respect to the total mass of the cross-linking composition in pellet form.

8. The cross-linking composition in pellet form according to claim 1 wherein the mass ratio of the quantities of zinc carboxylate and of the triazine derivative is comprised between 0.5 and 8.

9. The cross-linking composition in pellet form according to claim 1 wherein the quantity of zinc in the cross-linking composition in pellet form is comprised between 1% and 15% by mass, with respect to the total mass of the cross-linking composition in pellet form.

10. The cross-linking composition in pellet form according to claim 5 wherein the quantity of sulphur in the cross-linking composition in pellet form is comprised between 5% and 50% by mass, with respect to the total mass of the cross-linking composition in pellet form.

11. The cross-linking composition in pellet form according to claim 5 wherein the mass ratio between the quantities of zinc and sulphur is comprised between 0.01 and 0.3.

12. A method for preparing a cross-linking composition in pellet form comprising at least one polymer matrix, at least one cross-linking agent and at least one hydrogen sulphide inhibiting agent, the hydrogen sulphide inhibiting agent comprising at least one zinc carboxylate and at least one triazine derivative, and as the cross-linking composition in pellet form is obtained by extrusion at a temperature below 110° C.

13. A use of the cross-linking composition in pellet form for preparing cross-linked bitumen/elastomer compositions, the composition comprising at least one polymer matrix, at least one cross-linking agent and at least one hydrogen sulphide inhibiting agent, the hydrogen sulphide inhibiting agent comprising at least one zinc carboxylate and at least one triazine derivative.

14. The use of the cross-linking composition in pellet form according to claim 13, for reducing the hydrogen sulphide emissions during the preparation of cross-linked bitumen/elastomer compositions.

15. A method for preparing cross-linked bitumen/elastomer compositions utilizing at least one bitumen, at least one elastomer and at least one cross-linking composition in pellet form as defined in claim 1.

16. The method for preparing cross-linked bitumen/elastomer compositions according to claim 15 comprising the following stages
(i) heating at least one bitumen to a temperature comprised between 160° C. and 200° C.,
(ii) adding at least one elastomer and stirring the bitumen/elastomer mixture at a temperature comprised between 160° C. and 200° C.,
(iii) adding a cross-linking composition in pellet form, and stirring the bitumen/elastomer/cross-linking composition mixture in pellet form, at a temperature comprised between 160° C. and 200° C.

17. The method for preparing cross-linked bitumen/elastomer compositions according to claim 15 wherein the quantity of bitumen is comprised between 75% and 98% by mass, with respect to the total bitumen/elastomer composition/cross-linking composition in pellet form.

18. The method for preparing cross-linked bitumen/elastomer compositions according to claim 15 wherein the quantity of elastomer is comprised between 1% and 15% by mass, with respect to the total bitumen/elastomer composition/cross-linking composition in pellet form.

19. The method for preparing cross-linked bitumen/elastomer compositions according to claim 15 wherein the quantity of cross-linking composition in pellet form is comprised between 0.05% and 5% by mass, with respect to the total bitumen/elastomer composition/cross-linking composition in pellet form.

20. The method for preparing cross-linked bitumen/elastomer compositions according to claim 15 wherein the ratio between the quantities of sulphur and elastomer is comprised between 0.005 and 0.05.

21. A cross-linked bitumen/elastomer composition capable of being obtained by the preparation method as defined in claim 15.
